(19) United States
(12) Patent Application Publication
(10) Pub. No.: US 2020/0193351 A1
(43) Pub. Date: Jun. 18, 2020

(54) Value Index Score

(71) Applicant: Cadreon LLC, San Francisco, CA (US)

(72) Inventors: Tushar Patel, San Francisco, CA (US); Ravi Kiran Nukala, Union City, CA (US)

(73) Assignee: Cadreon LLC, San Francisco, CA (US)

(21) Appl. No.: 16/221,514

(22) Filed: Dec. 15, 2018

(51) Int. Cl. G06Q 10/06; G06Q 30/02; G06F 16/906; G06F 17/18

(52) U.S. Cl. CPC G06Q 10/06393; G06F 17/18; G06F 16/906; G06Q 30/0201

(57) ABSTRACT

Embodiments of the invention provide a technical solution by generating a value index score based on aggregation of a value from a combination of features as a unit. In one embodiment, instead of generating a value index score based on a collection of features with each feature being a discrete parameter, aspects of the invention generate the value index score while accounting for weights of a combination of features as a unit. Furthermore, embodiments of the invention generate a weight value for each feature and that the weight, not only will it be a factor in the calculation, but also be modifiable in response to other factors of the features.

### BACKGROUND

Service sectors deal with payers and providers constantly, and payers constantly evaluate providers' performances. One of the biggest and sometimes most important factor is value. In order to evaluate value—performance as it relates to cost, there are various models or measures that aim to provide a score, a value index score, to assist decision makers of payers and providers to better assess performances to meet expectations.

In the advertising technology industry, at a very basic level, a value index may identifying set of features, for example, such as quality, demand, performance, competitiveness, and price for a deal (Agreement between Buyer and Seller). A value index score may be generated to guide the campaign managers and programmatic specialists of the platform to understand whether the deal they are selecting from a particular publisher, advertiser, or a demand-side platform (DSP) combination is optimal or not.

Existing technology applies a process that involves identifying a set of features on the deal performance and provides a prediction in a form of a score based on historical data using Machine Learning (ML) algorithms.

Unfortunately, the technical problem with such approach includes its failure to identify the value of a set of a certain features as a combination, rather than just the value of individual features. The technical problem with such failure is a failure to account for a data structure (and data storage for data to be processed) and a corresponding algorithm to consume or process such combination in the data structure. Moreover, there is no algorithmic expression that accounts for different weights of these combination in the final value index score.

### SUMMARY

Embodiments of the invention provide a technical solution by generating a value index score based on aggregation from a combination of features as a unit. In one embodiment, instead of generating a value index score based on a collection of features with each feature being a discrete parameter, aspects of the invention generate the value index score while accounting for weights of a combination of features as a unit. Furthermore, embodiments of the invention generate a weight value for each feature and that the weight, not only will it be a factor in the calculation, but also be modifiable in response to other factors of the features.

Moreover, embodiments of the invention further evaluate and aggregate data such as historical performance data from demand side platforms and unity marketplace, which includes data from supply side platforms (SSPs). Such evaluation may adjust the weight to further improve accuracy and aid demand side and supply side for better predictions.

### BRIEF DESCRIPTION OF DRAWINGS

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

FIG. 1 is a diagram illustrating an overall sequence according to one embodiment of the invention.

FIG. 2 is a diagram illustrating a data structure for a value index score according to one embodiment of the invention.

FIGS. 3A to 3E are diagram illustrating weight assignment to attributes according to one embodiment of the invention.

FIGS. 4A to 4L

FIGS. 5A to 5E are graphical user interface (GUI) views of providing a value index score to a user according to one embodiment of the invention.

FIG. 6 is a diagram illustrating a portable computing device according to one embodiment of the invention.

FIG. 7 is a diagram illustrating a remote computing device according to one embodiment of the invention.

### DETAILED DESCRIPTION

Embodiments of the present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

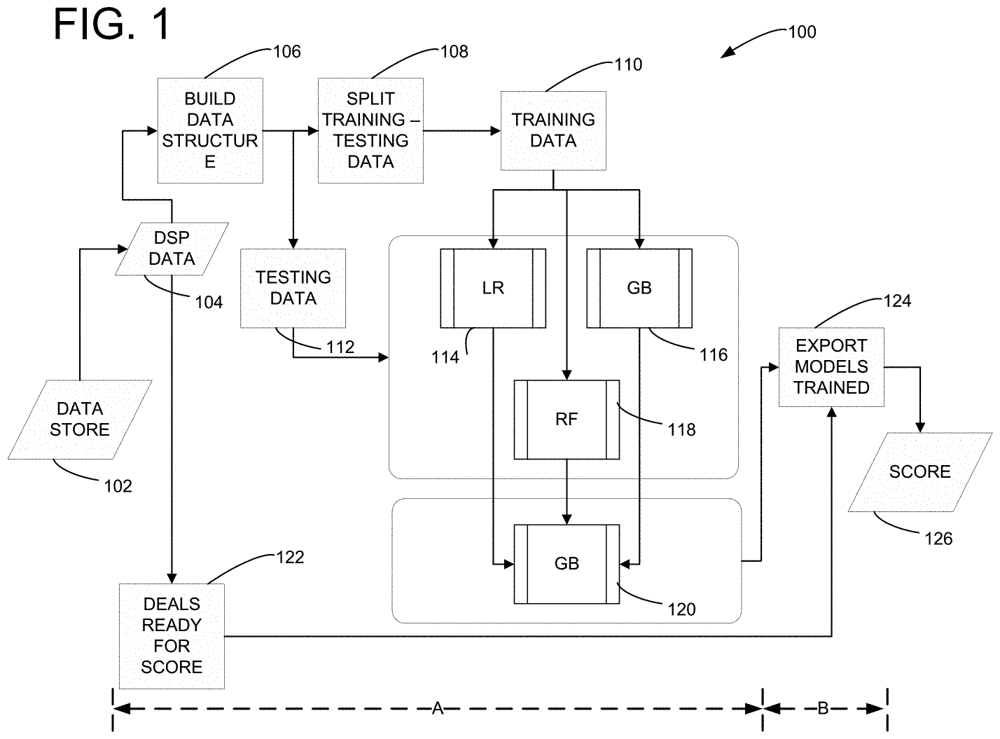

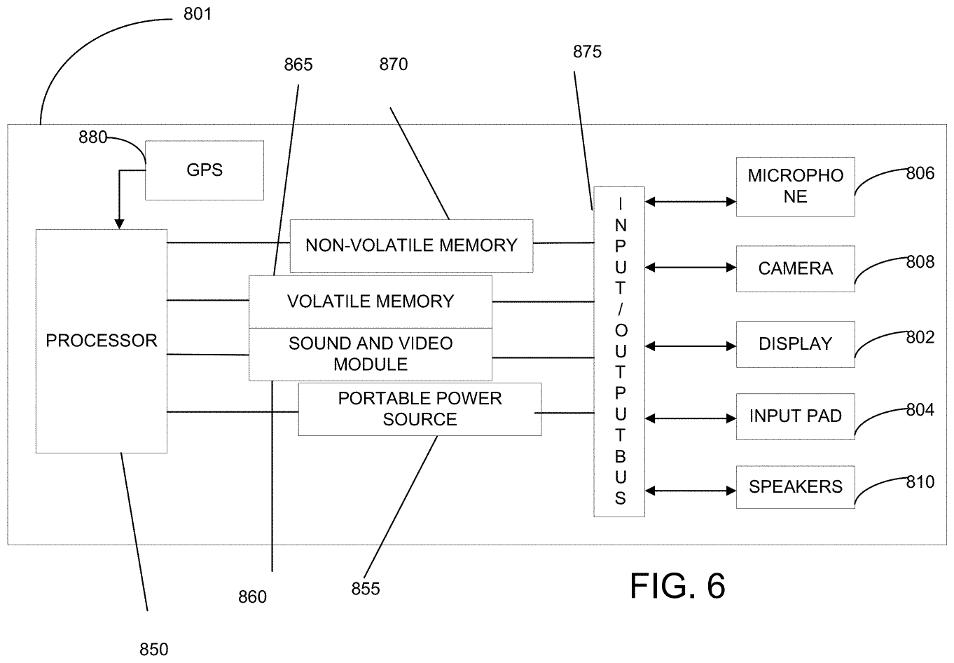

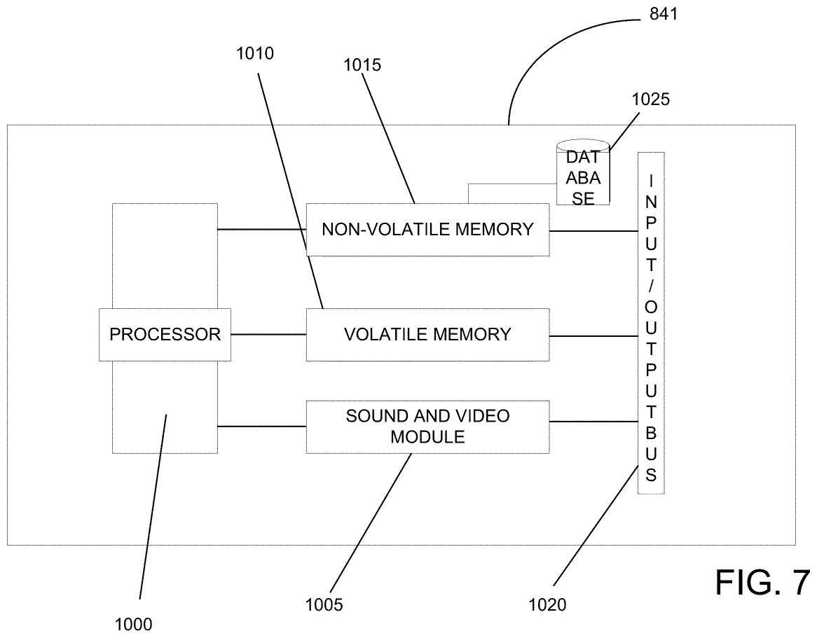

Referring now to FIG. 1, an operational system 100 diagram illustrates an overview of aspects of the invention. In one embodiment, the operational system 100 may be performed by a device 801 in FIG. 6 or device 841 in FIG. 7. In another embodiment, the operational system 100 may be executed by a combination of the device 801 and the device 841 via network connections.

In one example, the system 100 provides a model for determining value index score of a certain deal or transaction that may be received from a data store 102 or from demand side platform (DSP) data 104. In one example, the system 100 may receive deals may have data 122 ready for scoring. The value index score may provide an indication of a value of a deal. In one embodiment, the system 100 provides one or more sequence of steps in determining the score.

In one example, the system 100 may classify the one or more deals by applying a logistic regression analysis. For example, in any deal, a payer may wish to determine, after receiving quotes from providers for an advertising campaign, how to choose a quote. This is a binary or dichotomous determination, but affected a plurality of factors or features of the quote. Similarly, the provider, in improving its future chances of landing a successful deal with a payer, may wish to know how to close the deal. As such, the decision to accept or reject the deal may be treated as a binary or dichotomous (e.g., Yes or No). In one embodiment, the logistic regression analysis may describe data and explain the relationship between one dependent binary variable and one or more nominal, ordinal, interval or ratio-level independent variables.

In one embodiment, the logistic regression analysis may be applied to classify the one or more deals that are received. In one example, each of the deals may include parameters, metrics, etc., that comprise each of the deals.

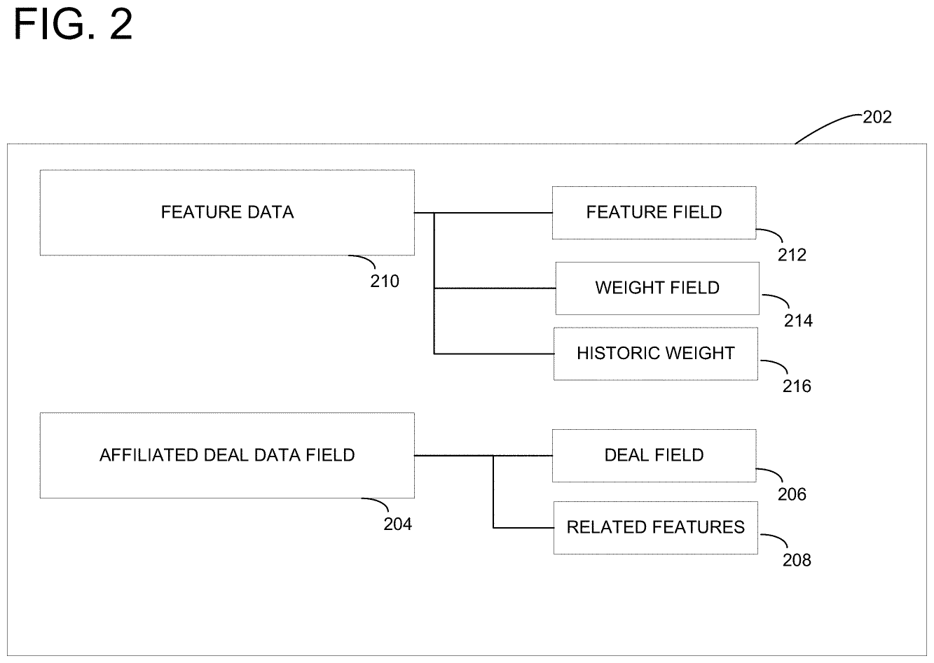

Referring now to FIG. 2, a diagram illustrates a data structure for representing a deal. For example, the data structure 202 may include a field 204 for storing data relating to the deal. For example, the field 204 may store a codename of the deal or other identifier information. The field 204 further includes subfields 206 and 208. In one example, the subfield 206 may include further details or conditions of the deal, such as deal offer date, response date, contact information, etc. The subfield 208 may further include data such as related features of the deal in the field 204.

The data structure 202 further may include a data field 210 for each feature of the deal. For example, the data field 210 may include a name of the feature. In another embodiment the data field 210 may include subfields such as fields 212, 214, and 216. In one example, the field 212 may include one or more parameters of the feature, such as data type, data restrictions, data duration, data source, metrics of the data, etc. In another embodiment, the field 214 may include a weight assigned or calculated by the system 100. In another example, the field 216 may include any historical weight that has previously assigned or calculated for a particular feature.

In another embodiment, the field 210 may further be applicable for an individual metric of a feature. As previously discussed, prior technology fails to account for granular significance at feature or event metrics level. There was also no common data structure to account for such significance. Aspects of the invention provide the common data structure, such as the data structure 202, to store and present the weighted data of each feature or metric such that intelligent analysis may be performed therewith.

In one embodiment, table 1 below illustrates one example of contents or details of DSP performance data:

TABLE 1

| | Available | Pending | Future |
|---|---|---|---|
| Sources | The Trade Desk | DBM | Other DSPs |
| | TubeMogul | | |
| Metrics | Viewability | Bid Requests | Video Starts |
| | Post Click | Bid Counts | Video Quartile |
| | Conversations | Impressions | Completes |
| | Post View Conversions | Win Rate | Video Skips |
| | Advertiser | Avg. Bid CPM | Clicks |
| | Campaign | Viewable | Bid Strategy |
| | Line item | Impressions | eCPM |

In one embodiment, the data structure 202 may store the above data as part of a deal when the performance data is one of the many features to be evaluated before providing the value index score of a deal.

As another example, table 2 illustrates some of the contents or details of unity marketplace data:

TABLE 2

| | Available | Pending | Future |
|---|---|---|---|
| Sources | Unity Marketplace | Publishers | |
| | SSP | | |
| | Magna | | |
| Metrics | Deal Name | URLs | Media Type |
| | Publisher Name | Deal Type | App |
| | Floor Rate | Is Promoted | Verification Partner |
| | AdFormats | DSP | Location Based |
| | Categories | Advertiser | Targeting |
| | Geographies | Magna | Strategic Partner |
| | Post Click | Foundational | Contact Information |
| | Conversations | | |
| | Post View Conversions | | |
| | Advertiser | | |
| | Campaign | | |
| | Line item | | |

In one embodiment, the data structure 202 may store the above data as part of a deal when the unity marketplace data is one of the many features to be evaluated before providing the value index score of a deal.

It is to be understood that other data may be stored or included without departing from the scope or spirit of embodiments of the invention. For example, as illustrated in Tables 1 and 2, columns “Available,” “Pending,” and “Future” provide potential growth of the data contents that may become available and therefore may be part of a weighted consideration in determining the score.

Referring back to FIG. 1, the system 100 may strategically use the data from DSP at 104 to build a data structure at 106 according to one embodiment of the invention. For example, the data structure 202 may be used as the building block of such structure or preparing data for classification. In another embodiment, the system 100 may perform preprocessing steps at 106. For example, the system 100 may remove outliers or perform additional calculations for variables in the data. At 108, the system 100 may split the data for testing at 112 or for training at 110. In one embodiment, the split may be an arbitrary ratio, such as 70% for training and 30% for testing. It is to be understood that the ratio may be modified manually or automatically without departing from the scope or spirit of embodiments of the invention.

In one embodiment, as part of the training, the system 100 may feed the data to a linear regression analysis at 114, a gradient boosting analysis at 116, and a random forest analysis at 118 to refine the data as part of the classification or determining the weight. It is also contemplated that other analysis mechanisms or algorithms may be employed without departing from the scope or spirit of embodiments of the invention. Moreover, as the data is fed into these various analysis, the system 100 may also perform cross data validation and fine tuning or hyper tuning of parameters within the data.

In one embodiment, the system 100 may stack the linear regression, the gradient boosting, and the random forest to further enhance the value of the score.

In one embodiment, the linear regression model or analysis may aim to determine a function that draws a linear relationship between a set of input features and the value a payer or a provider would like to predict. In one embodiment, this generated function may serve as a model for future analysis.

In another embodiment, the random forest analysis may use decision trees as the starting point. However, decision trees tend to and are very prone to overfitting. In one embodiment, in order to achieve higher accuracy, the system 100 may modify the random forest analysis to create a large number of them based on bagging. In one embodiment, bagging may include:

Generate n different bootstrap training sample;

Train algorithm on each bootstrapped sample separately; and

Average the predictions at the end.

In one embodiment, the system 100 may resample the data over and over and for each sample train a new classifier. Different classifiers may over-fit (e.g., reducing variance) the data in a different way, and through voting those differences may be averaged out.

In another embodiment, an additional gradient boosting analysis at 120 may be used as a boosting method, which may build on weak classifiers. In one embodiment, boosting may include the following:

Draw a random subset of training samples d1 without replacement from the training set D to train a weak learner C1;

Draw second random training subset d2 without replacement from the training set and add 50 percent of the samples that were previously falsely classified/misclassified to train a weak learner C2;

Find the training samples d3 in the training set D on which C1 and C2 disagree to train a third weak learner C3; and

Combine all the weak learners via majority voting.

In one embodiment, the system 100 may add a classifier at a time, so that the next classifier is trained to improve the already trained ensemble. In another embodiment, for random forest analysis, the system 100 may, each iteration, use the classifier to be trained independently from the rest.

With the above steps and process, in one embodiment, 70% of the data may be for training and 30% of the data may be used for testing the model and derive the final output.

In one embodiment, the system 100 may employ machine learning (ML) or other artificial intelligence (AI) algorithm or models to perform one or more of the analysis. In one embodiment, the system 100 may designate processes under “A” as part of a training stage while “B” as a prediction stage of the processing.

In another embodiment, the system 100, through the recursive and AI processing, the system may export models trained 124 before generating a score at 126.

In one embodiment, as the system 100 receives data from deals and through the analysis methods discussed above, the system 100 may calculate and determine a weight for each of the features in a given deal. In addition, each of the weights may be further modified and updated based on the various models to increase the accuracy of the prediction.

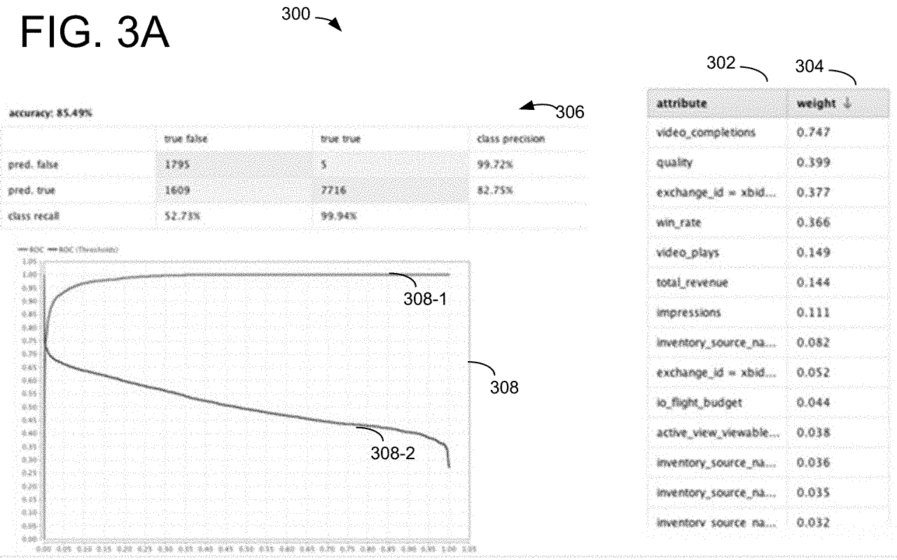

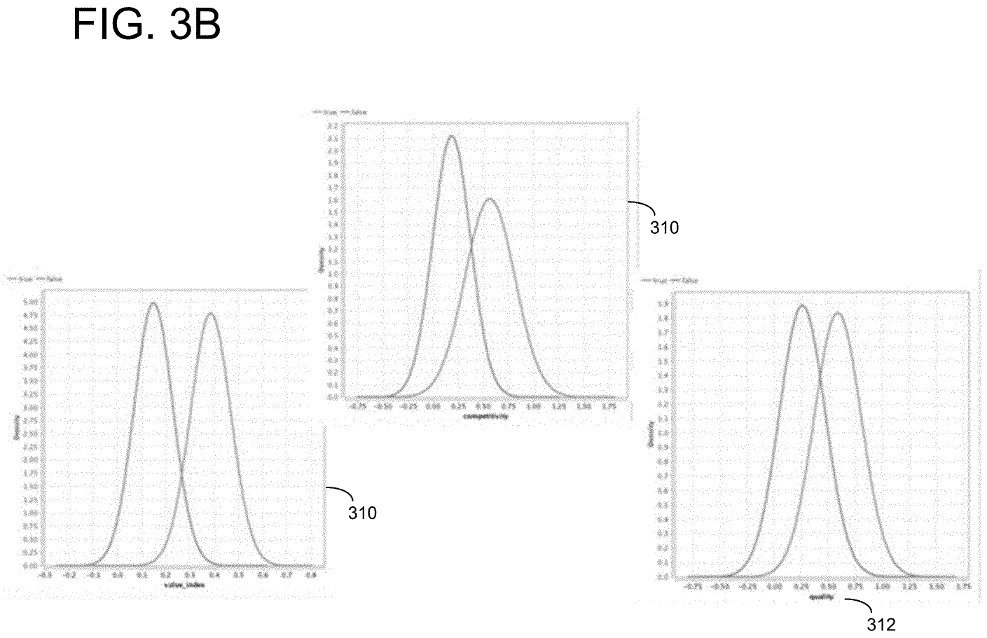

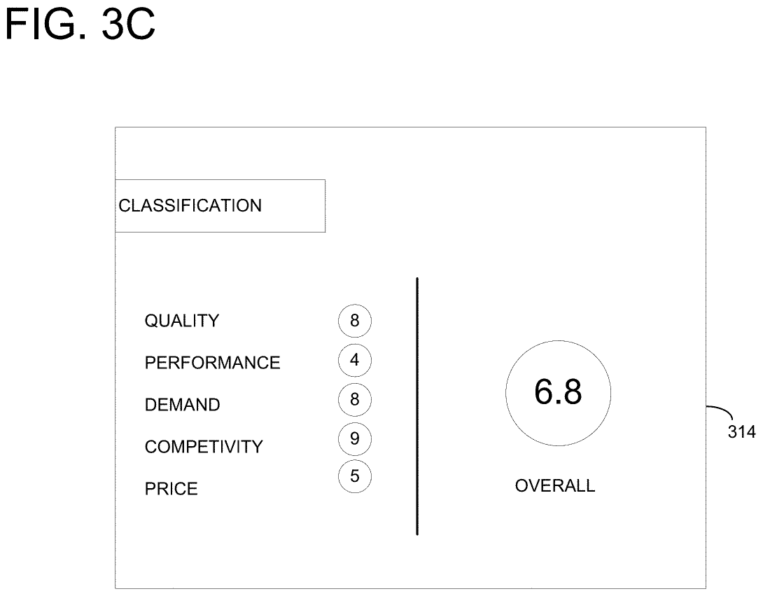

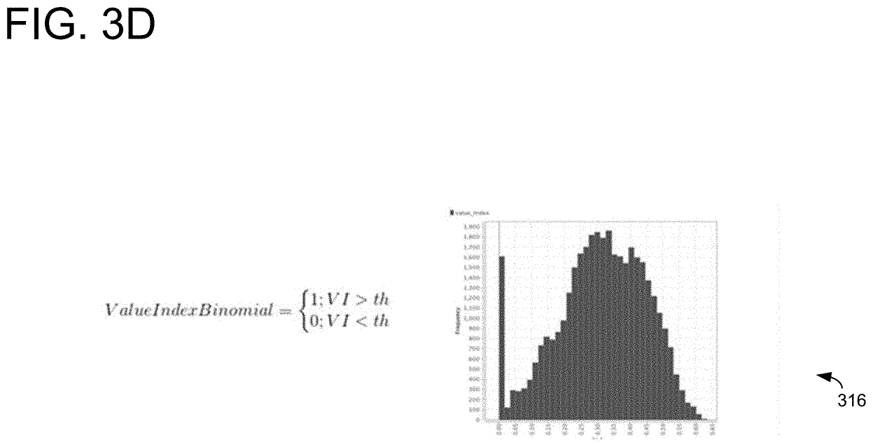

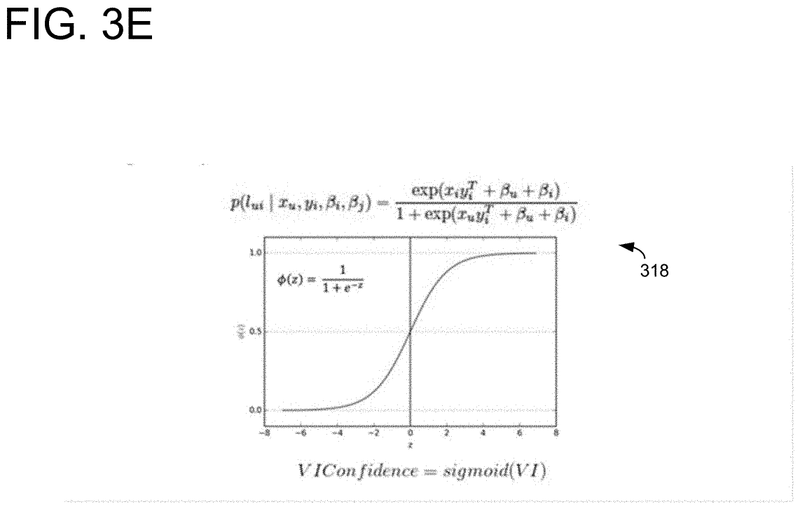

In one embodiment, the system 100 may assign weights to features or metrics of a given deal. FIG. 3A may illustrate a sample graphical user interface (GUI) 300 showing such classification or determination according to one embodiment of the invention. A line 308-1 represents run of channel (ROC) and a line 308-2 represents ROC threshold.

For example, the system 100 includes, based on analysis of the data, a table showing a column 302 for one or more attributes or metrics of a feature or a feature and a column 304 for a weight assigned or calculated for the corresponding attribute or metric or feature.

In one embodiment, the weights may be determined by the logistic regression analysis to classify from machine learning libraries or other AI algorithms. In another embodiment, the GUI 300 may further include a table 306 showing an accuracy rating or value and various controls based on the weights of the attributes after the application of the logistic regression. Moreover, the GUI 300 may also provide a graph 308 showing a distribution of significance level of the attributes. In one embodiment, the graph 308 may be dynamic and correspond to the weights such that as the weights are modified, the distribution of the graph 308 may be modified accordingly.

Referring now to FIG. 3B, three exemplary graphs 310, 312, and 314 may show a distribution in response to the weights' impact on a certain feature after the application of the logistic regression. For example, the graph 310 may illustrate the impact of value_index; the graph 312 may illustrate the impact of competitiveness or competivity, and the graph 314 may illustrate the impact of quality. In this example, the y-axis of the graphs 310, 312, and 314 may indicate density value.

In another embodiment, in using the data structure 202, the system 100 may further identify proxies or metrics. For example, the following illustrates metrics or features that may be a representation of another element of a deal:

Quality—Viewability;

Performance—(click-through rate) CTR or (pay-per-click) PCC;

Demand—Bid Rate (“BR”);

Competivity—Win Rate (“WR”);

Price—Clearing Price (“CR”)

In one embodiment, the system 100 may provide FIG. 3C showing not only the value index score for the entire deal but also a value score for each of the features. In one embodiment, the score for the feature may be derived from a function of the attributes or metrics of the features as previously discussed.

In another embodiment, an exemplary prediction function of a value index score may be:

VI=f(V,CTR,BR,WR,CR)

VI=Σ(α1*Quality)+(α2*Performance)+(α3*Competitivity)+(α4*Demand)+(α5*Price)

FIG. 3D may illustrate, in another embodiment, a graph 316 showing the value index (in the x-axis) versus frequency (in the y-axis).

In another embodiment, FIG. 3E illustrates a validation model that may be used by the system 100. For example, as discussed above and in FIG. 1, a current validation model 318 may use 30% of the data for testing and 70% of the data may be used for predicting the score. The model expression 318, may over time, may be modified in building the confidence of the model and improve the accuracy.

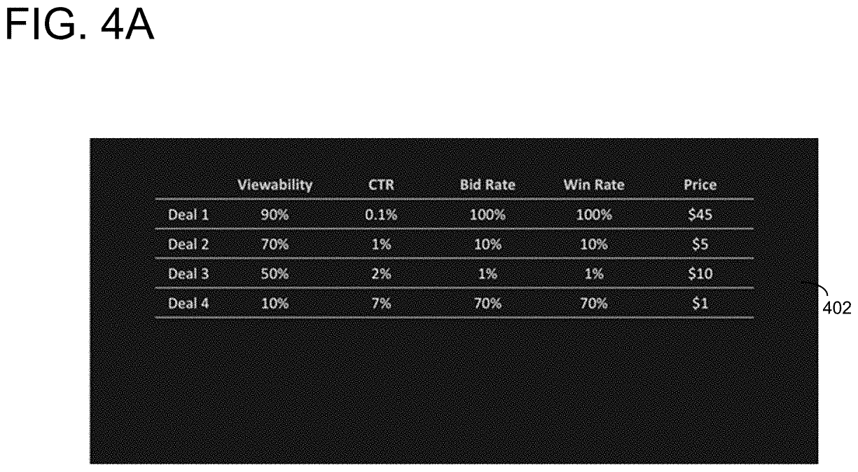

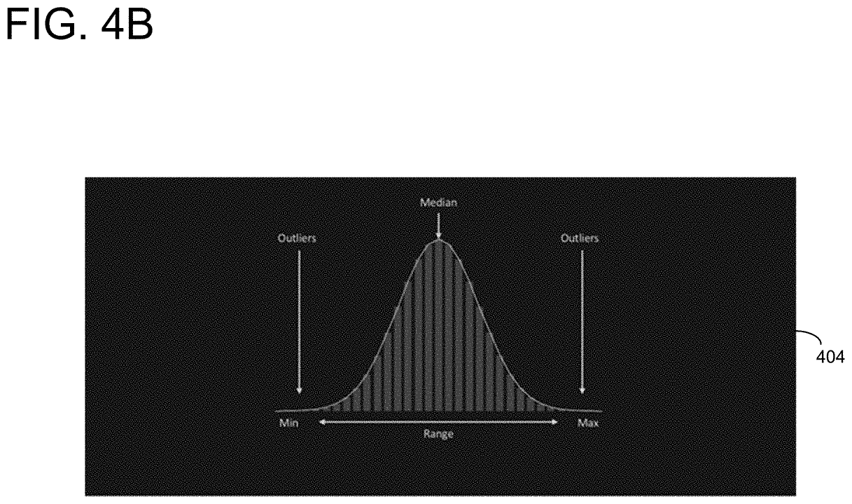

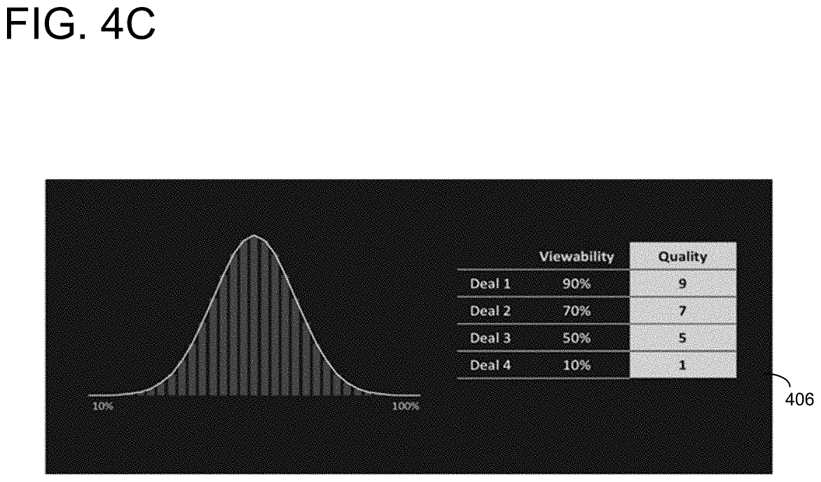

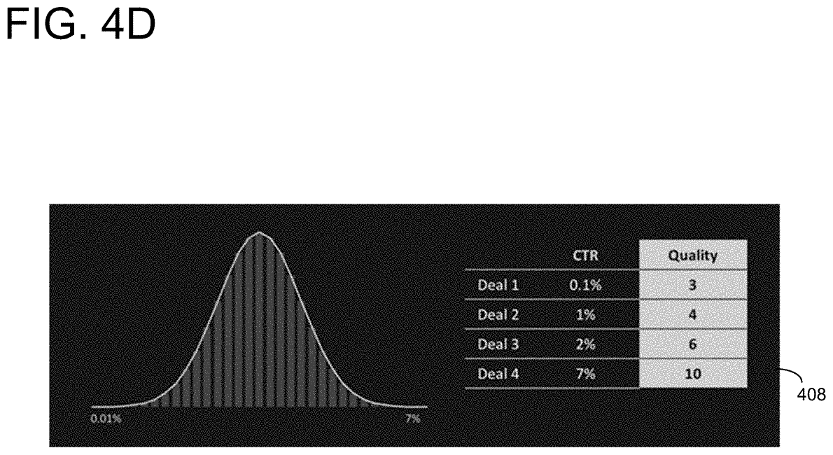

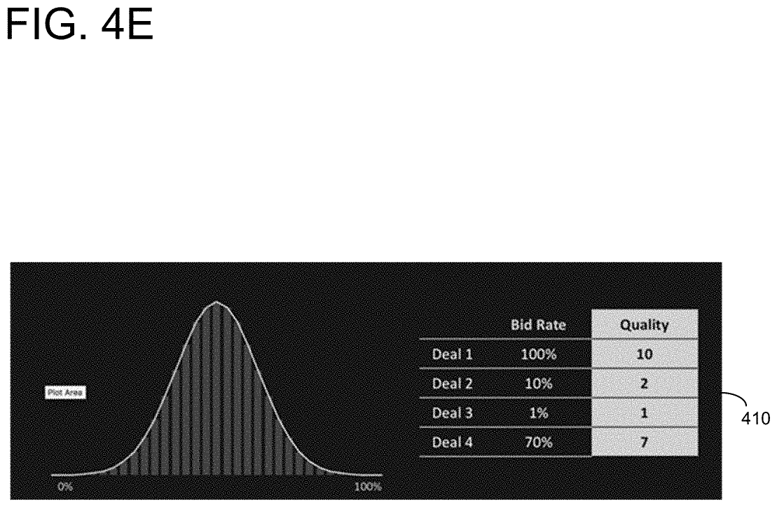

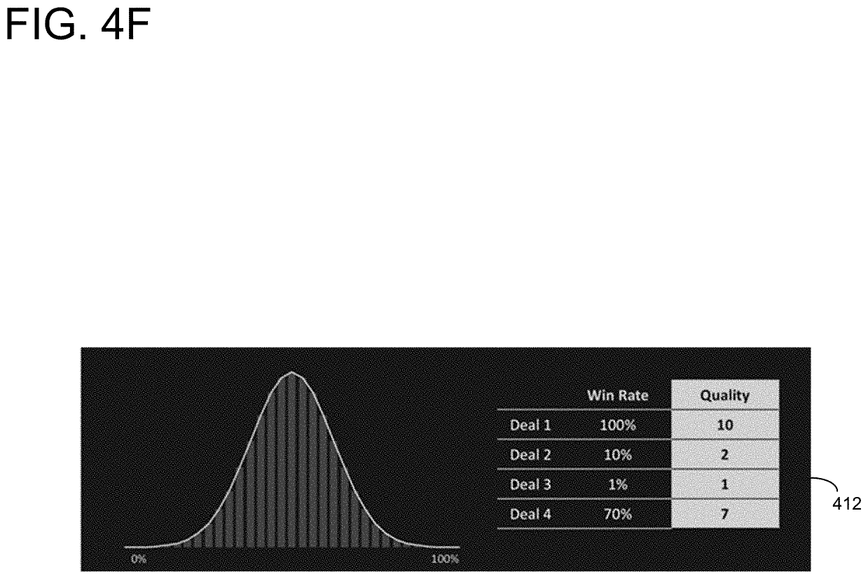

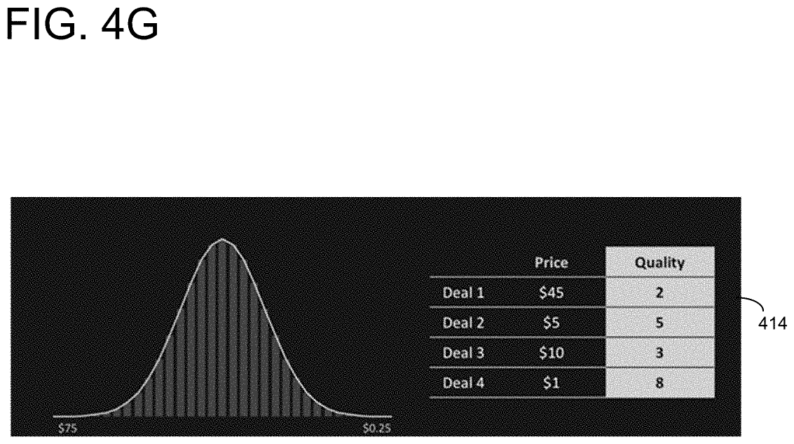

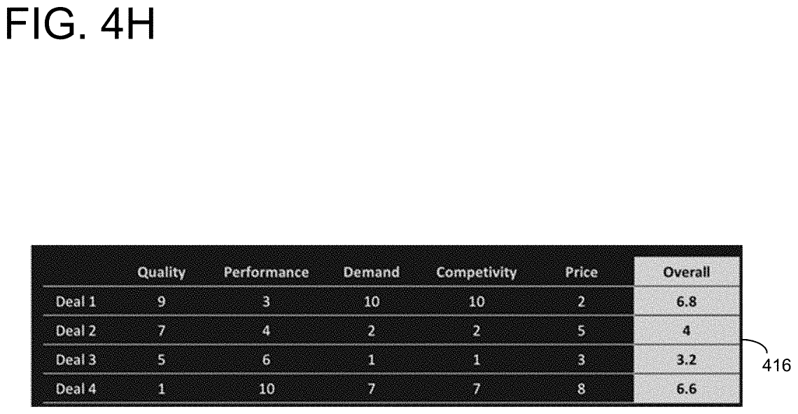

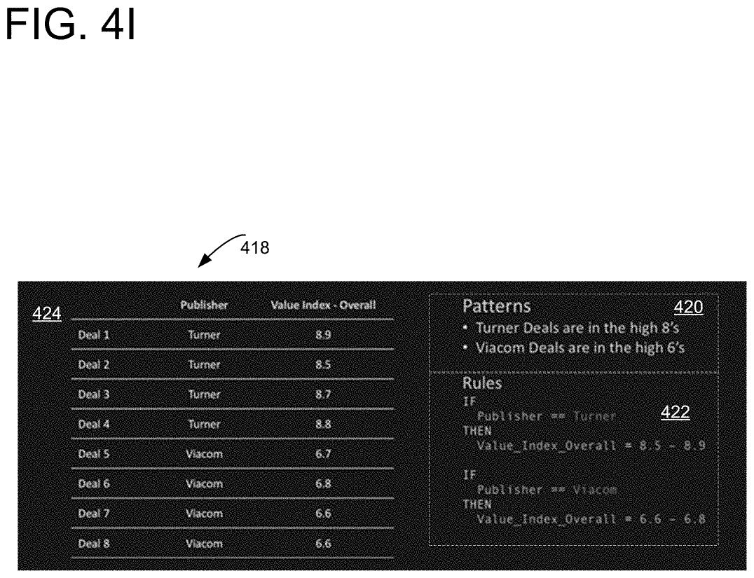

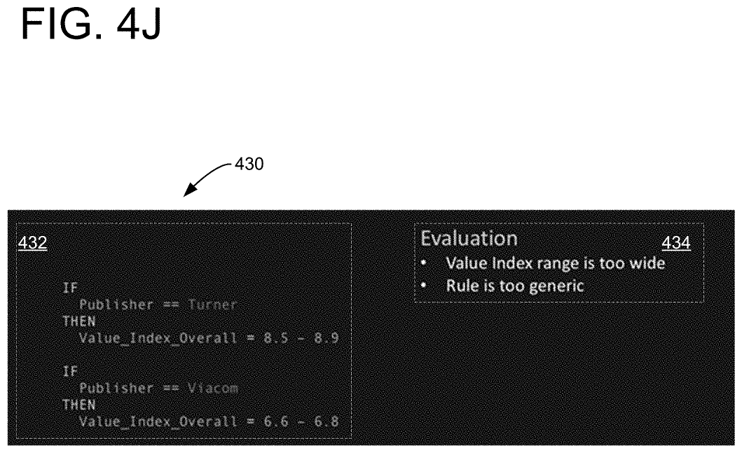

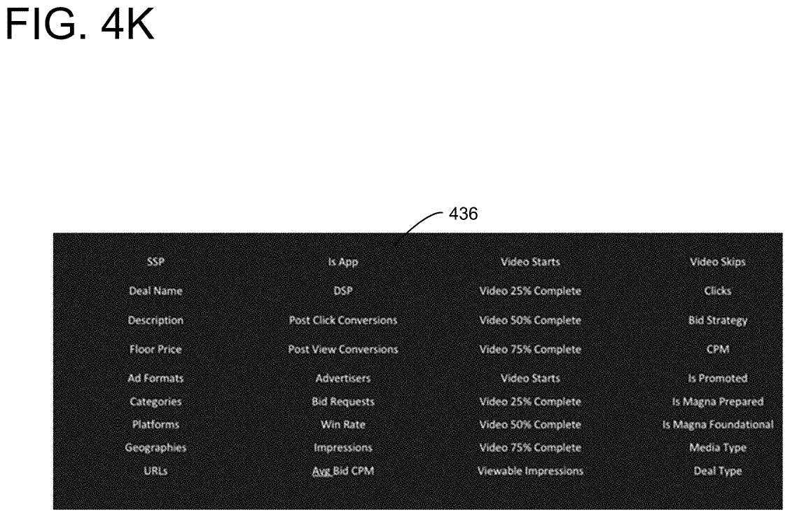

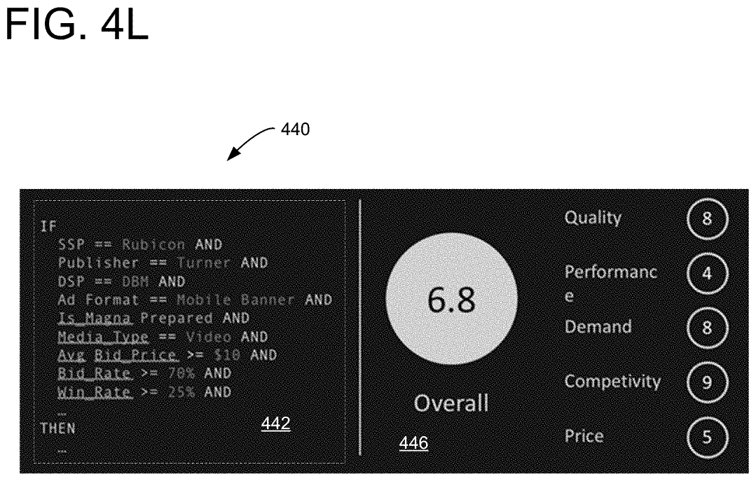

FIGS. 4A through 4L are exemplary GUIs illustrating aspects of the invention. In one embodiment, the GUIs in FIGS. 4A through 4L may be presented to the user on a number of devices for payers or providers.

In one embodiment, FIG. 4A illustrates a table 402 a set of deals showing each having its respective values from features such as viewability, CTR, Bid Rate, Win Rate, and Price. FIG. 4B illustrates a graph 404 showing, after classification of the attributes, based on the various weights assigned to each feature, how a deal may be processed. In one example, the system 100 performs analysis of the distribution and may determine where is the outliers.

FIG. 4C illustrate a score for each deal in terms of the Quality feature. As previously discussed, “viewability” may be interpreted or considered as a proxy for “quality.” As such, FIG. 4C illustrates a combination of a graph and table 406 identifying scores for the deals for the feature “Quality.”

FIG. 4D illustrates a combination of a graph and table 408 identifying scores for the deals for the feature “Performance.”

FIG. 4E illustrates a combination of a graph and table 410 identifying scores for the deals for the feature “Demand.”

FIG. 4F illustrates a combination of a graph and table 412 identifying scores for the deals for the feature “Competivity.”

FIG. 4G illustrates a combination of a graph and table 414 identifying scores for the deals for the feature “Price.”

In summary, FIG. 4H illustrates a final table 416 showing a summary view of the individual scores for each feature in each deal and an overall score for the deal.

In one embodiment, using the 4 deals illustrated from FIGS. 4A through 4H, the attributes within each feature and each deal may be used, by the system 100, for the system 100 to assist a publisher or an advertiser predict a score for other deals.

For example, as illustrated in FIG. 4I, a view 418 provides a list 424 of deals with information such as “Publisher,” and “Overall Value Index Score.” The view 418 further includes a notification pane 420 and a rules pane 422. The notification pane 420 may provide a summary or a general observation of the list of deals in the list 424. For example, in the illustration in FIG. 4I, the notification pane 420 provides:

Patterns:

Turner deals are in the high 8's;

Viacom deals are in the high 6's.

In one embodiment, the message or content of the notification pane 420 may be generated by the system 100. In another embodiment, the message or content of the notification pane 420 may be edited, generated, or modified by a system administrator or an analysis. In another embodiment, the message or content of the notification pane 420 may be composed jointly by the system 100 and a user.

The view 418 further may provide the rules pane 422 showing an exemplary syntax of the rules that produce the message or content in the notification pane 420.

In a further embodiment, in FIG. 4J, a view 430 may provide an evaluation pane 434 providing an observation of the message or content in the notification pane 420. For example, the evaluation pane 434 may provide a critique about the Pattern that was described. For example, the evaluation in the evaluation pane 434 may be:

Evaluation:

Value index range is too wide;

Rule is too generic.

In this example, the view 430 may show the rules previously displayed in the rules pane 422 to a new area 432.

As such, in FIG. 4K, a view 436 may provide a list of possible additional attributes that may be used to further provide additional insights to provide a better prediction. In this embodiment, the list of attributes or metrics may be generated based on prior models. In another embodiment, the list in the view 436 may be provided in response to retrieve the related features field 208 in the data structure 202. In other words, the data structure 202 may provide a comprehensive set of structure that enables the system 100 to solve the problem with previous technologies using technical solutions. In one embodiment, the view 436 may be interactive. In one embodiment, the user may select, using an input device or a user's finger, one or more attributes or metrics listed. For example, the user may select SSP, Publisher, DSP, Ad Format, Is Magna Prepared, Media Type, Avg Bid_Price, Bid_Rate, and Win_Rate. Once selected, the user may then be presented with FIG. 4L, a view 440 that may include a rules pane 442 and a score pane 446.

In this example, the rules pane 442 may be interactive as well where the user may enter parameters or values for each of the metrics or attributes selected in the view 436. In one embodiment, the system 100 may enable substantially simultaneous execution or evaluation of the rules as the user enters the values for the attributes or metrics in the rules pane 442. In one embodiment, the rules 442 may provide cues (either visually or audibly) to the user if the rules' syntax is not satisfied. The view 440 may then, after the execution of a customized rules provided by the user, provide real-time or simultaneous real-time scores for the deal.

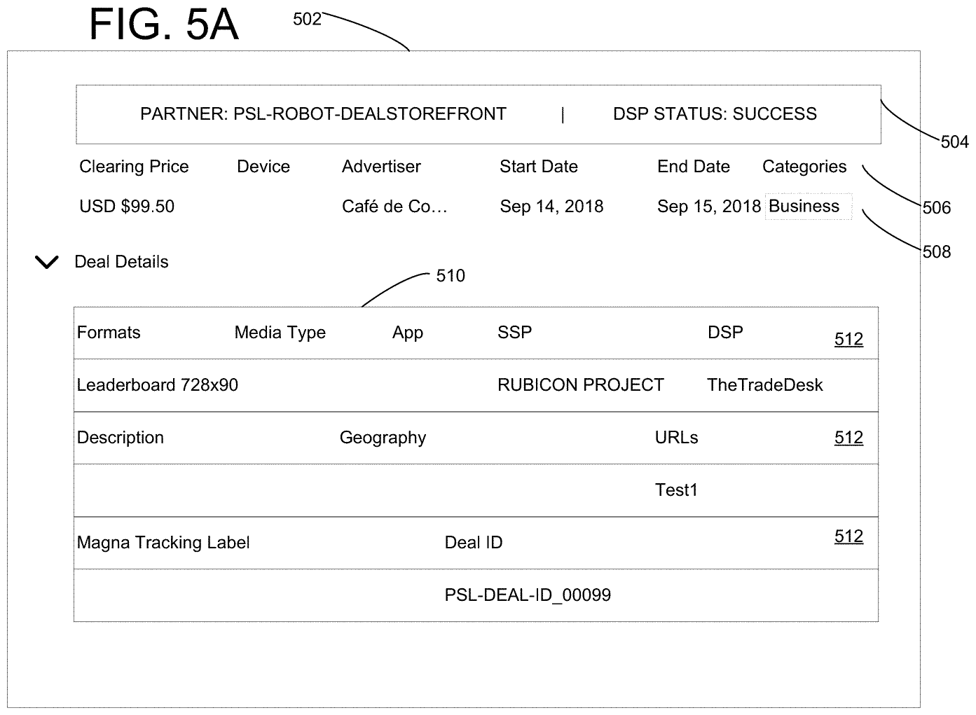

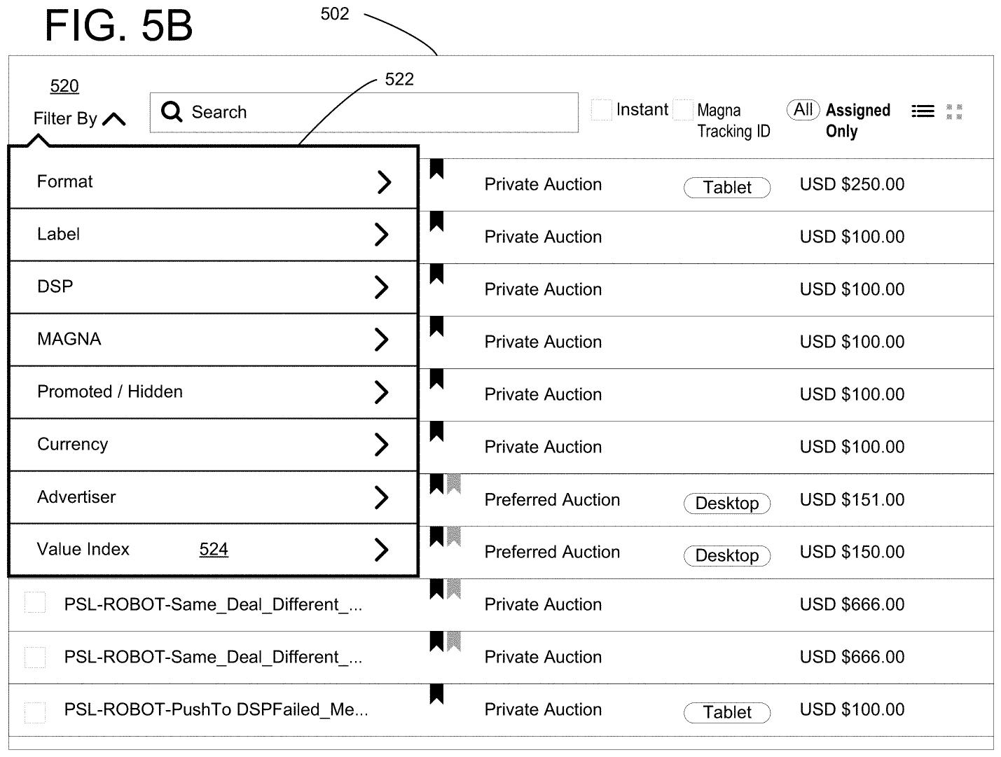

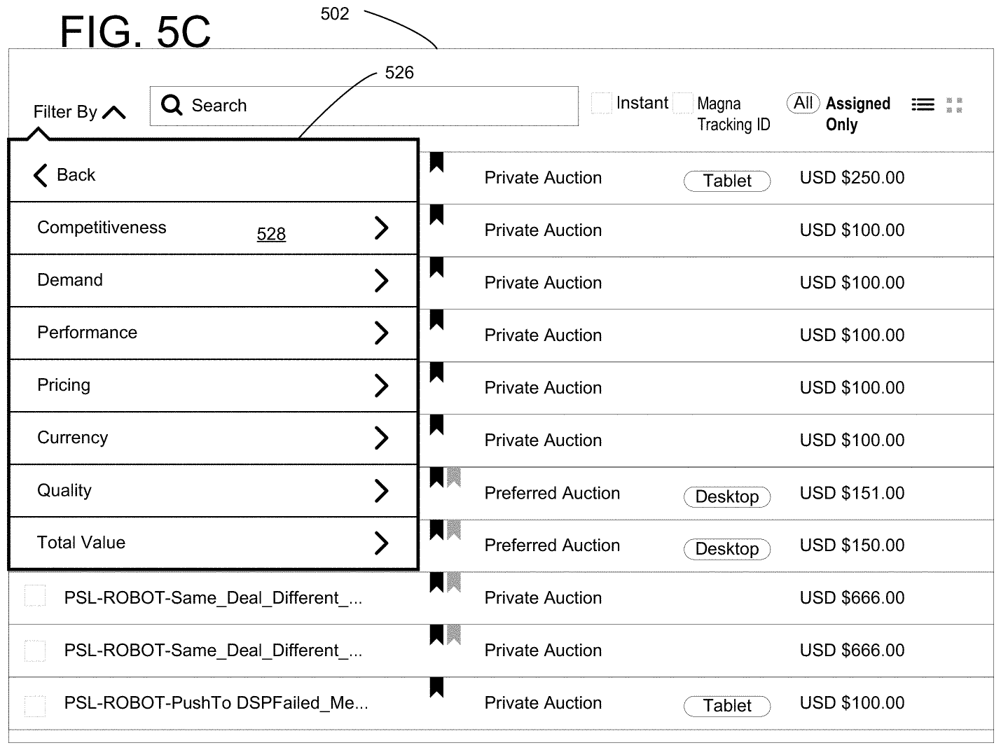

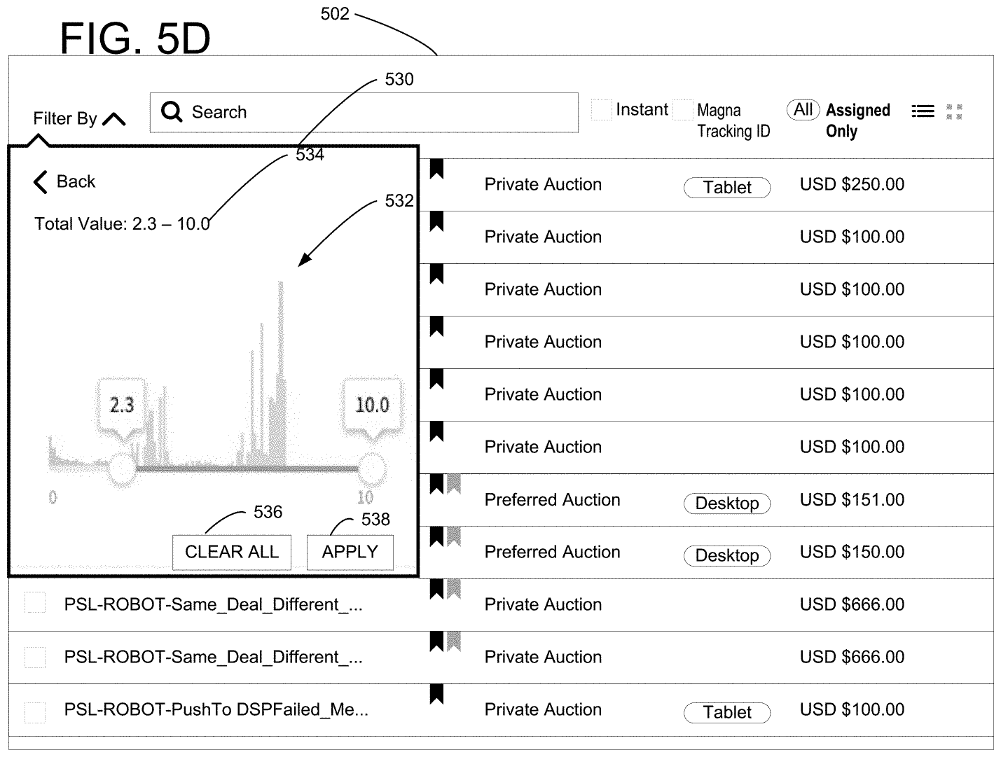

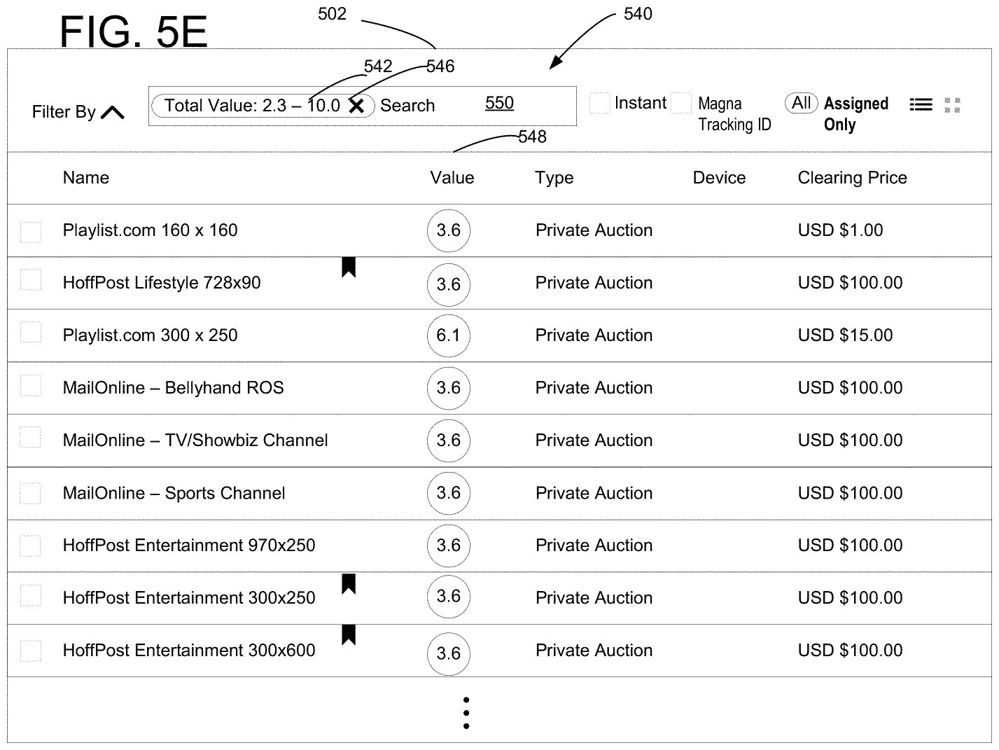

Moreover, FIG. 5A through 5E illustrate additional interactive GUIs according to one embodiment of the invention.

In FIG. 5A, a GUI 502 may present a window-like view showing a header 504 to the user. In one embodiment, the header 504 may provide information such as “Partner,” and “DSP status.” In another example, a title pane 506 may provide a table heading information of a particular deal associated with a customer or client. The GUI 502 may further include an initial set of details corresponding to items in the title pane 506 in 508.

The GUI 502 further includes a table 510 providing headers 512 showing additional details of the deal, such as “format,” “deal ID,”, etc.

Referring now to FIG. 5B, the GUI 502 may provide another view 520 illustrating a list of deals. In order to facilitate the users to analyze or review a particular deal, aspects of the invention provide an overlay window or menu 522 in response to the user selecting “FILTER BY” to set a condition in how to further filter or narrow the display of the different deals in the view 520. In this example, the menu 522 may obscure some of the contents in the view 520. In one example, the menu 522 may be transparent and may allow the user to see the contents behind the menu 522. Moreover, in a further embodiment, the menu 522 may provide one or more functions that the user may select. It is to be understood that the functions shown in FIG. 5B are not exhaustive and may not be considered as limiting. Other functions may be provided without departing from the scope or spirit of embodiments of the invention. In this example, the user may select the “VALUE INDEX” function 524.

Upon selecting the “VALUE INDEX” function 524 on the menu 522, the GUI 502 may provide another menu 526 showing additional sub-functions under the “VALUE INDEX” function. The user may select “COMPETIVITY” function 528 from the menu 526 as one of the features that the user may wish to review. In one example, the functions in the menu 526 may be treated as one or more features of a given deal. Again, it is to be understood that other features may be added without departing from the scope or spirit of embodiments of the invention.

Upon selecting the “COMPETIVITY” function 528, the GUI 502 may provide a view 530 to interact with the user. In this example, the view 530 may provide a graph or a graphical representation showing in simultaneously or substantially simultaneously real-time changes to the feature “COMPETIVITY”. Similarly, the view 530 may provide text confirmation or value of the changes. In one embodiment, the changes may represent changes in the score for the feature “COMPETIVITY.” Once the user is satisfied with the changes, the user may select a “APPLY” button 538 to request the system 100 to execute the changes or a “CLEAR ALL” button 536 to cancel the changes.

Referring now to FIG. 5E, in response to the changes executed by the system 100, a view 540 may be presented in the GUI 502. For example, the view 540 may provide that a box 542 showing “TOTAL VALUE: 2.3-10.0” in a search box 550 next to “FILTER BY”. This reflects to the changes made by the user in the view 530. In addition, the box 542 may include an “X” icon 546 indicating that the user may select the icon 546 to cancel the condition. In response to the condition configured by the user, a view 548 provides a different listing of deals satisfying the condition configured by the user.

It is to be understood that the user may add other conditions by repeat some of the illustrated operations above without departing from the scope or spirit of embodiments of the invention.

FIG. 6 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages, and different API platforms.

In one embodiment, a portable computing device 801 may be a mobile device 112 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 6 may be a simplified illustration of the physical elements that make up a portable computing device 801 and FIG. 7 may be a simplified illustration of the physical elements that make up a server type computing device 841.

FIG. 6 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 7. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be general purpose computers that may have, among other elements, a microprocessor (such as from the Intel Corporation, AMD, ARM, Qualcomm, or MediaTek); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, iOS, Android, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving verification and discovery of merchants or stores that do not accept non-cash payment devices or that do accept non-cash payments devices but differentiate them between local/national issued ones versus foreign issued ones. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A computerized method for generating a value index score comprising:
receiving elements of an advertising deal from a data source;
conducting a logistic regression analysis to classify the received elements to identify metrics of the advertising deal;
constructing a data structure for each of the metrics, said data structure comprising data fields for storing data of a metric, data of a weight calculated for the metric, historical weight data of the metric, data for an affiliated deal, data of related metrics of the affiliated deal;
determining the weight of each of the metric using the logistic regression analysis;
storing the determined weight in the data structure; and
as a function of the weight of each of the metrics of the advertising deal, calculating a value index score for the advertising deal.

2. The computerized method of claim 1, wherein receiving elements of the advertising deal comprises receiving a plurality of advertising deals.

3. The computerized method of claim 2, wherein the data source of the plurality of advertising deals comprises one or more of the following: a demand side platform and a supply side platform.

4. The computerized method of claim 1, further comprising classifying each of the plurality of advertising deals to one or more metrics using a logistic regression algorithm within each of the plurality of advertising deals.

5. The computerized method of claim 1, further comprising refining the weight of each of the metrics after logistic regression analysis using one or more of the following: a linear regression analysis, a gradient boosting analysis, and a random forest analysis.

6. The computerized method of claim 1, further comprising receiving historical weight data of each of the metrics, said historical weight data of each of the metrics being stored in the data structure.

7. The computerized method of claim 6, further comprising conducting the logistic regression analysis to the weight of each of the metrics as a function of the received historical weight data.

8. A computerized system for generating a value index score comprising:
a processor for receiving elements of an advertising deal from a data source connected to the processor via a network connection;
a graphical user interface (GUI) for providing to a user the received elements of the advertising deal;
wherein the processor conducts a logistic regression analysis to classify the received elements to identify metrics of the advertising deal;
a distributed data storage unit connected to the processor via the network connection generating a data structure for each of the metrics, said data structure comprising data fields for storing data of a metric, data of a weight calculated for the metric, historical weight data of the metric, data for an affiliated deal, data of related metrics of the affiliated deal;
wherein the processor determines the weight of each of the metric using the logistic regression analysis;
wherein the distributed data storage unit storing the determined weight in the data structure; and
as a function of the weight of each of the metrics of the advertising deal, wherein the processor calculates a value index score for the advertising deal.

9. The computerized system of claim 8, wherein the processor receives a plurality of advertising deals.

10. The computerized system of claim 9, wherein the data source of the plurality of advertising deals comprises one or more of the following: a demand side platform and a supply side platform.

11. The computerized system of claim 8, wherein the processor refines the weight of each of the metrics after logistic regression analysis using one or more of the following: a linear regression analysis, a gradient boosting analysis, and a random forest analysis.

12. The computerized system of claim 8, wherein the processor receives historical weight data of each of the metrics, wherein the distributed data storage unit stores the historical weight data of each of the metrics in the data structure.

13. The computerized system of claim 12, wherein the processor conducts the logistic regression analysis to the weight of each of the metrics as a function of the received historical weight data.

14. A non-transitory computer readable medium stored thereon computer-executable instructions embodied in a software product, wherein the computer-executable instructions when executed by a processor comprising:
receiving elements of an advertising deal from a data source;
conducting a logistic regression analysis to classify the received elements to identify metrics of the advertising deal;
constructing a data structure for each of the metrics, said data structure comprising data fields for storing data of a metric, data of a weight calculated for the metric, historical weight data of the metric, data for an affiliated deal, data of related metrics of the affiliated deal;
determining the weight of each of the metric using the logistic regression analysis;
storing the determined weight in the data structure; and
as a function of the weight of each of the metrics of the advertising deal, calculating a value index score for the advertising deal.

15. The non-transitory computer readable medium of claim 14, further comprising classifying each of the plurality of advertising deals to one or more metrics using a logistic regression algorithm within each of the plurality of advertising deals.

16. The non-transitory computer readable medium of claim 14, wherein receiving elements of the advertising deal comprises receiving a plurality of advertising deals.

17. The non-transitory computer readable medium of claim 16, wherein the data source of the plurality of advertising deals comprises one or more of the following: a demand side platform and a supply side platform.

18. The non-transitory computer readable medium of claim 14, further comprising refining the weight of each of the metrics after logistic regression analysis using one or more of the following: a linear regression analysis, a gradient boosting analysis, and a random forest analysis.

19. The non-transitory computer readable medium of claim 14, further comprising receiving historical weight data of each of the metrics, said historical weight data of each of the metrics being stored in the data structure.

20. The non-transitory computer readable medium of claim 19, further comprising conducting the logistic regression analysis to the weight of each of the metrics as a function of the received historical weight data and further comprising updating the value index score for the advertising deal.
